(19) United States
(12) Patent Application Publication
(10) Pub. No.: US 2015/0349640 A1
(43) Pub. Date: Dec. 3, 2015

(54) CONTROL CIRCUIT AND POWER SUPPLY CIRCUIT

(71) Applicant: SOCIONEXT INC., Yokohama-shi (JP)

(72) Inventor: Yuji ITO, Hachioji (JP)

(21) Appl. No.: 14/700,947

(22) Filed: Apr. 30, 2015

(30) Foreign Application Priority Data
May 30, 2014 (JP) 2014-112513

(51) Int. Cl. H02M 3/158

(52) U.S. Cl. CPC H02M 3/158

(57) ABSTRACT

A control circuit includes: a signal generating circuit configured to generate a PWM signal; and a drive control circuit configured to alternately turn on a first transistor and a second transistor in accordance with the PWM signal, the first transistor and the second transistor being connected in series between a wiring to which a first voltage is supplied and a wiring to which a reference potential is supplied. The drive control circuit turns on one of the first transistor and the second transistor when detecting that an electric potential of an N well of the first transistor or the second transistor in triple-well structure, connected to a wiring to which a second voltage lower than the first voltage is supplied via a resistor becomes lower than a threshold value after the other of the first transistor and the second transistor is turned off.

### CROSS-REFERENCE TO RELATED APPLICATION

This application is based upon and claims the benefit of priority of the prior Japanese Patent Application No. 2014-112513, filed on May 30, 2014, the entire contents of which are incorporated herein by reference.

### FIELD

The embodiments relate to a control circuit and a power supply circuit.

### BACKGROUND

A DC-DC converter in a synchronous rectification system is a power supply circuit that supplies a certain output voltage to a load circuit based on an input voltage. The DC-DC converter in a synchronous rectification system includes: as illustrated in FIG. 10A, for example, first and second transistors (NMOS transistors) MTR1 and MTR2 that are connected in series between a wiring to which an input voltage VCC is supplied and a wiring to which a reference potential (for example, a ground potential) is supplied and supply an electric current to a load circuit; and a drive control circuit 101 that on-off controls the transistors MTR1 and MTR2. Diodes D1 and D2 are parasitic diodes of the transistors MTR1 and MTR2. The drive control circuit 101 alternately turns on the transistors MTR1 and MTR2 based on a PWM (Pulse Width Modulation) signal according to an output voltage, and thereby the output voltage is supplied to the load circuit.

For example, as illustrated in FIG. 10A, when the first transistor MTR1 is turned on and the second transistor MTR2 is turned off, a node PA is connected to the input voltage VCC and from the input voltage VCC, an electric current is supplied to the load circuit via the first transistor MTR1 and a coil L1 (a state A). As illustrated in FIG. 10B, for example, when the first transistor MTR1 is turned off and the second transistor MTR2 is turned on, the node PA is connected to the reference potential and from the reference potential, an electric current is supplied to the load circuit via the second transistor MTR2 and the coil L1 (a state B). By performing switching between the state A illustrated in FIG. 10A and the state B illustrated in FIG. 10B, a certain output voltage is supplied to the load circuit.

Here, with regard to the switchover from the state A to the state B, or from the state B to the state A, when switching of one transistor from on to off is delayed as compared to switching of the other transistor from off to on, the transistors MTR1 and MTR2 are both turned on as illustrated in FIG. 10C. When the transistors MTR1 and MTR2 are turned on simultaneously, a short-circuit is caused between the input voltage VCC and the reference potential and a shoot-through current flows via the transistors MTR1 and MTR2. Thus, when switching between the state A and the state B is performed, a period called dead time is provided, and as illustrated in FIG. 10D, the transistors MTR1 and MTR2 are both turned off (a state C). By switching the state to the state A, to the state C, to the state B, to the state C, to the state A, and to the state C . . . in order, the transistors MTR1 and MTR2 are prevented from being turned on simultaneously.

At the dead time, as the state C illustrated in FIG. 10D, the transistors MTR1 and MTR2 are both off. However, when switching the state to the state C from the state A or the state B, the DC-DC converter in a synchronous rectification system that has the coil L1 on the load circuit side and supplies an electric current tries to supply the same electric current as that in the prior state (the state A or the state B) due to the property of the coil L1. At this time, namely in the state C, an electric current is supplied to the node PA from the reference potential via the parasitic diode D2 between a back gate and a drain of the second transistor MTR2.

When the second transistor MTR2 has a triple-well structure as illustrated in a cross section of FIG. 11B, a parasitic NPN transistor TR2 is formed by an N well 115, a P well (a back gate) 114, and an N-type region (an N-type diffusion layer) 113 being a drain. 111 denotes a gate and 112 denotes a source. At the dead time as illustrated in FIG. 11A, an electric current is supplied to the node PA from the reference potential via the parasitic diode D2 of the second transistor MTR2, and when the electric potential of the node PA (the drain 113) becomes an electric potential lower than the reference potential, via the NPN transistor TR2, an electric current is supplied to the node PA from the input voltage VCC to which the N well 115 is connected.

There has been proposed a DC-DC converter designed to be prevented from being deteriorated or damaged by a drive signal being stopped from being supplied to transistors of the DC-DC converter when a detection transistor detects that a Schottky barrier diode functioning as a flywheel diode is brought into an open state due to any cause (refer to Patent Document 1, for example).

[Patent Document 1] Japanese Laid-open Patent Publication No. 2011-83104

In the previously described DC-DC converter in a synchronous rectification system, an on-resistance of the second transistor MTR2 is much smaller than a resistance component of the parasitic diode D2. Thus, a power loss in the state C illustrated in FIG. 10D is larger than that in the state B illustrated in FIG. 10B, so that a period of the state C, namely the dead time is preferably short. However, when the dead time is shortened excessively, there is a risk that the state is brought into the state illustrated in FIG. 10C and a shoot-through current flows.

As one example of this measure, as illustrated in FIG. 12, there has been proposed a method of optimizing the dead time by detecting the electric potential of the node PA, namely an output voltage. A logical product operation circuit (AND circuit) 121 and inverters 122, 123, 124, and 125 illustrated in FIG. 12 are provided in the drive control circuit 101. To the AND circuit 121, a PWM signal PWMCS to be a low level when the second transistor MTR2 is turned on is input via the inverter 122 and the electric potential of the node PA (the output voltage) is input via the inverter 123. An output of the AND circuit 121 is supplied to the gate of the second transistor MTR2 via the two inverters 124 and 125 connected in series.

When the first transistor MTR1 is switched from on to off and the second transistor MTR2 is turned on, the output of the AND circuit 121 is maintained at a low level, (which will be also described as “L” hereinafter), regardless of the PWM signal PWMCS until the electric potential of the node PA (the output voltage) becomes an electric potential corresponding to a low level. Thus, the second transistor MTR2 is not turned on until the electric potential of the node PA (the output voltage) becomes an electric potential corresponding to a low level even if the PWM signal PWMCS becomes “L.”

Then, when the electric potential of the node PA (the output voltage) decreases to an electric potential corresponding to a low level, the output of the AND circuit 121 becomes the same logic level as that of the PWM signal PWMCS. Thus, as long as the PWM signal PWMCS is “L,” the second transistor MTR2 is turned on. As above, turning on of the second transistor MTR2 is delayed until the electric potential of the node PA (the output voltage) decreases to an electric potential corresponding to a low level, and the time when the first and second transistors MTR1 and MTR2 are both turned off is optimized.

However, the technique described in FIG. 12 is applicable to the case where a withstand voltage of the first and second transistors MTR1 and MTR2 and a withstand voltage of transistors in the drive control circuit 101 to receive the electric potential of the node PA (the output voltage) are the same. That is, the technique is applicable to the case where the input voltage VCC and a power supply voltage VDD of the drive control circuit 101 are the same or substantially the same, and is not applicable to the case where the input voltage VCC and the power supply voltage VDD of the drive control circuit 101 are sufficiently different. This is because when the gate withstand voltage of the transistors in the drive control circuit 101 to receive the electric potential of the node PA (the output voltage) is not the input voltage VCC or more, it is not possible to perform detection of the electric potential of the node PA (the output voltage).

Generally, in the drive control circuit 101, a transistor low in withstand voltage is used for the purpose of miniaturization. In a DC-DC converter in a bootstrap system illustrated in FIG. 13, for example, the input voltage VCC (10 V to 48 V, for example) and the power supply voltage VDD of the drive control circuit 101 (5 V, for example) are greatly different. A drive control circuit of the DC-DC converter illustrated in FIG. 13 includes delay circuits 131 and 135, inverters 132, 133, 134, 136, 137, 139, and 140, a level shift circuit 138, a diode 141, and a capacitor 142.

The PWM signal PWMCS becomes a high level, (which will be also described as “H” hereinafter), when the first transistor MTR1 is turned on, and the PWM signal PWMCS becomes “L” when the second transistor MTR2 is turned on. The PWM signal PWMCS is input to the delay circuit 131 via the inverter 132. An output of the delay circuit 131 is supplied to the gate of the second transistor MTR2 via the two inverters 133 and 134 connected in series.

The PWM signal PWMCS is input to the delay circuit 135 via the two inverters 136 and 137 connected in series. An output of the delay circuit 135 is shifted to a logic signal based on the electric potential of the node PA from a logic signal based on the reference potential by the level shift circuit 138, and then is supplied to the gate of the first transistor MTR1 via the two inverters 139 and 140 connected in series. The diode 141 is a bootstrap diode and the capacitor 142 is a bootstrap capacitor.

A configuration example of the delay circuits 131 and 135 is illustrated in FIG. 14A. As illustrated in FIG. 14A, a delay circuit includes an AND circuit 151, inverters 152, 153, and 154, a transistor (a PMOS transistor) TR151, a transistor (an NMOS transistor) TR152, a resistor R151, and a capacitance C151.

FIG. 14B illustrates an operation of the delay circuit illustrated in FIG. 14A. When sufficient time elapses after a signal input to an input terminal IN changes to “L,” inputs SINA and SINB to the AND circuit 151 are both “L” and a signal output from an output terminal OUT (an output of the AND circuit 151) is “L.” When the signal input to the input terminal IN changes to “H” from “L,” the input SINA to the AND circuit 151 changes to “H” immediately, but the input SINB is delayed by the resistor R151, the capacitance C151, and the like to then change to “H,” and thus the signal output from the output terminal OUT (the output of the AND circuit 151) changes to “H” after a certain delay elapses.

When sufficient time elapses after the signal input to the input terminal IN changes to “H,” the inputs SINA and SINB to the AND circuit 151 are both “H” and the signal output from the output terminal OUT (the output of the AND circuit 151) is “H.” When the signal input to the input terminal IN changes to “L” from “H,” the input SINA to the AND circuit 151 changes to “L” and the signal output from the output terminal OUT (the output of the AND circuit 151) changes to “L” immediately.

As above, in the delay circuits 131 and 135, when the input signal changes to “H” from “L,” the output signal is delayed to then change to “H” from “L,” and when the input signal changes to “L” from “H,” the output signal changes to “L” from “H” immediately. Thus, in the DC-DC converter illustrated in FIG. 13, when switching from off to on, the first and second transistors MTR1 and MTR2 are delayed to then be switched to on after the PWM signal PWMCS changes, and when switching from on to off, the first and second transistors MTR1 and MTR2 are switched to off immediately as soon as the PWM signal PWMCS changes. In this manner, switching from off to on is delayed, and thereby the first and second transistors MTR1 and MTR2 are prevented from being both turned on.

However, the configuration using the delay circuits illustrated in FIG. 13 needs to provide a certain amount of delay time in consideration of variations in manufacture of elements, temperature fluctuation, external load causes, and the like, and it is not possible to optimize the time when the first and second transistors MTR1 and MTR2 are both turned off, namely the dead time.

### SUMMARY

One aspect of a control circuit includes: a signal generating circuit configures to generate a pulse width modulation signal; and a drive control circuit configured to alternately turn on a first transistor and a second transistor in accordance with the pulse width modulation signal, the first transistor and the second transistor being connected in series between a wiring to which a first voltage is supplied and a wiring to which a reference potential is supplied. At least one of the first transistor and the second transistor is formed in a P well formed in an N well, and an N-type diffusion layer to be a source or a drain is formed in the P well, and the N well is connected to a wiring to which a second voltage lower than the first voltage is supplied via a resistor. The drive control circuit turns on one of the first transistor and the second transistor when detecting that an electric potential of the N well of the first transistor or the second transistor becomes lower than a threshold value after the other of the first transistor and the second transistor is turned off.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating a configuration example of a power supply circuit in a first embodiment;

FIG. 2 is a view illustrating a configuration example of a PWM signal generating circuit in the first embodiment;

FIG. 3 is a view illustrating a configuration example of a drive control circuit in the first embodiment;

FIG. 4 is a timing chart illustrating an operation example of the power supply circuit in the first embodiment;

FIG. 5A and FIG. 5B are views used for explaining an operation of the power supply circuit in the first embodiment;

FIG. 6 is a timing chart illustrating an operation example of the power supply circuit in the first embodiment;

FIG. 7 is a timing chart illustrating an operation example of the power supply circuit in the first embodiment;

FIG. 8 is a view illustrating a configuration example of a drive control circuit in a second embodiment;

FIG. 9A and FIG. 9B are timing charts each illustrating an operation example of a power supply circuit in the second embodiment;

FIG. 10A to FIG. 10D are views used for explaining an operation of a DC-DC converter;

FIG. 11A and FIG. 11B are views each illustrating a current path at a dead time in the DC-DC converter;

FIG. 12 is a view used for explaining a control example of the DC-DC converter;

FIG. 13 is a view used for explaining another control example of the DC-DC converter;

FIG. 14A is a view illustrating a configuration example of a delay circuit; and

FIG. 14B is a view illustrating an operation of the delay circuit.

### DESCRIPTION OF EMBODIMENTS

Hereinafter, there will be explained embodiments based on the drawings.

### First Embodiment

There will be explained a first embodiment.

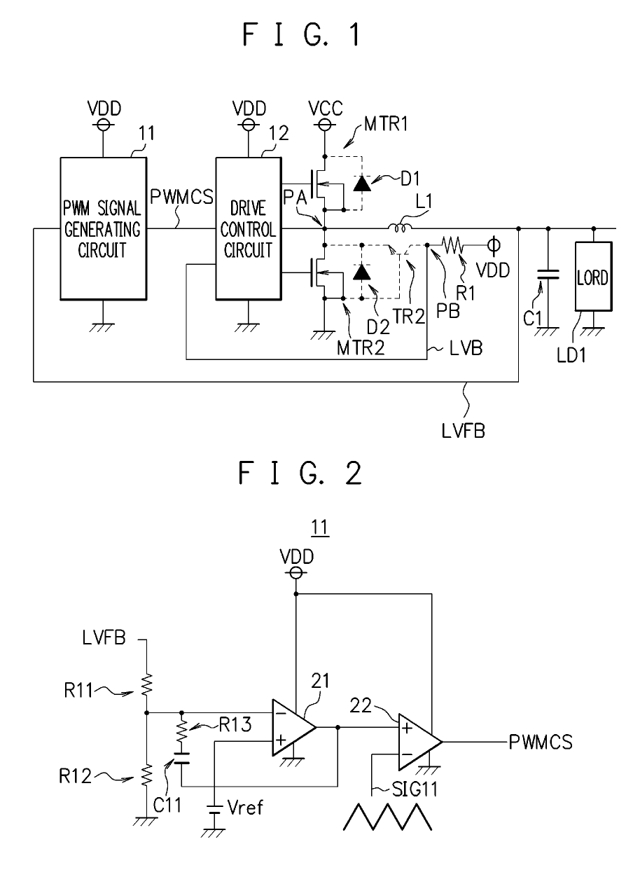

FIG. 1 is a view illustrating a configuration example of a power supply circuit (a DC-DC converter in a synchronous rectification system) in the first embodiment. A PWM (Pulse Width Modulation) signal generating circuit 11 generates a PWM signal PWMCS according to a feedback voltage (an output voltage) LVFB to output it. A drive control circuit 12 performs an on-off control so as to alternately turn on first and second transistors (NMOS transistors) MTR1 and MTR2 based on the PWM signal PWMCS output from the PWM signal generating circuit 11 and an electric potential LVB of a node PB. For example, as a power supply, a power supply voltage VDD is supplied to the PWM signal generating circuit 11 and the drive control circuit 12.

The first and second transistors MTR1 and MTR2 are connected in series between a wiring to which an input voltage VCC is supplied and a wiring to which a reference potential (for example, a ground potential) is supplied, and supply an electric current to a load circuit LD1. The input voltage VCC is a voltage higher than the power supply voltage VDD. The voltage of a node PA being a connection point of the first and second transistors MTR1 and MTR2 is smoothed by a coil L1 and a capacitance C1 to be a direct-current output voltage. This output voltage is fed back as the feedback voltage LVFB.

A diode D1 is a parasitic diode between a back gate and a drain of the first transistor MTR1. A diode D2 is a parasitic diode between a back gate and a drain of the second transistor MTR2. An NPN transistor (a bipolar transistor) TR2 is a parasitic transistor formed by an N well, a P well (a back gate), and an N-type region (an N-type diffusion layer) as a drain of the second transistor MTR2 in a triple-well structure. The second transistor MTR2 has a triple-well structure in which the P well is formed in the N well, and in the P well, the N-type diffusion layer to be a source or a drain is formed.

A collector of the parasitic NPN transistor TR2 (the N well of the second transistor MTR2) is connected to the power supply voltage VDD via a resistor R1. The P well (the back gate) and the source of the second transistor MTR2 are connected to the reference potential. A connection portion of the collector of the parasitic NPN transistor TR2 (the N well of the second transistor MTR2) and the resistor R1 is the node PB.

In the power supply circuit in the first embodiment illustrated in FIG. 1, when the first transistor MTR1 is turned on and the second transistor MTR2 is turned off (a state A), the node PA is connected to the input voltage VCC and from the input voltage VCC, an electric current is supplied to the load circuit LD1 via the first transistor MTR1. When the first transistor MTR1 is turned off and the second transistor MTR2 is turned on (a state B), the node PA is connected to the reference potential and from the reference potential, an electric current is supplied to the load circuit LD1 via the second transistor MTR2.

Further, when the first and second transistors MTR1 and MTR2 are both turned off from the state where one of the first and second transistors MTR1 and MTR2 is on (a state C), namely at a dead time, from the reference potential, an electric current is supplied to the load circuit LD1 via the parasitic diode D2 of the second transistor MTR2. Further, at the dead time (in the state C), from the power supply voltage VDD, an electric current is supplied to the load circuit LD1 via the parasitic NPN transistor TR2 of the second transistor MTR2.

The power supply circuit in the first embodiment illustrated in FIG. 1 switches the state to . . . the state A, to the state C, to the state B, to the state C, to the state A, to the state C, to the state B, to, . . . in order by PWM control performed by the PWM signal generating circuit 11 and the drive control circuit 12, to thereby supply a certain output voltage to the load circuit LD1. Further, an electric current flows to the parasitic NPN transistor TR2 of the second transistor MTR2, and thereby the power supply circuit detects that the first and second transistors MTR1 and MTR2 are both off and turns one of them on, and thereby the dead time is optimized and efficiency decrease is improved.

FIG. 2 is a view illustrating a configuration example of the PWM signal generating circuit 11. The PWM signal generating circuit 11 includes an error amplifier 21, a PWM comparator 22, resistors R11, R12, and R13, and a capacitance C11. The error amplifier 21 compares a voltage obtained by dividing the feedback voltage (the output voltage) LVFB by the resistors R11 and R12 and a set voltage Vref and outputs an error signal having a level according to the difference of the comparison. The PWM comparator 22 compares the error signal output from the error amplifier 21 and a triangular wave signal SIG11 output from a not-illustrated oscillator to output the PWM signal PWMCS.

The PWM signal PWMCS is output so as to turn the first transistor MTR1 on when the voltage obtained by dividing the feedback voltage LVFB by the resistors R11 and R12 becomes lower than the set voltage Vref and so as to turn the second transistor MTR2 on when the voltage obtained by dividing the feedback voltage LVFB by the resistors R11 and R12 becomes higher than the set voltage Vref, for example. The following explanation is performed on the condition that the PWM signal PWMCS is brought to a high level, (which will be also described as “H” hereinafter), when the first transistor MTR1 is turned on and the PWM signal PWMCS is brought to a low level, (which will be also described as “L” hereinafter), when the second transistor MTR2 is turned on.

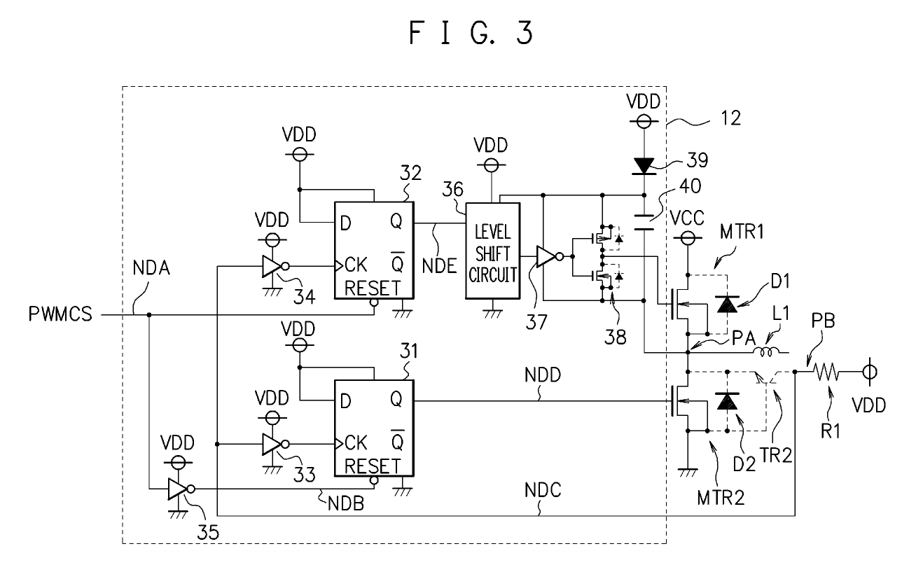

FIG. 3 is a view illustrating a configuration example of the drive control circuit 12. The drive control circuit 12 includes flip-flops 31 and 32, inverters 33, 34, 35, 37, and 38, a level shift circuit 36, a diode 39, and a capacitance 40. In the flip-flop 31, a fixed signal at “H” (the power supply voltage VDD) is input to a D input (a data input) terminal, the electric potential of the node PB is input to a CK input (a clock input) terminal via the inverter 33, and the PWM signal PWMCS is input to a RESET input (a reset input) terminal via the inverter 35. A Q output (a data output) terminal of the flip-flop 31 is connected to the gate of the second transistor MTR2.

In the flip-flop 32, a fixed signal at “H” (the power supply voltage VDD) is input to a D input terminal, the electric potential of the node PB is input to a CK input terminal via the inverter 34, and the PWM signal PWMCS is input to a RESET input terminal. A Q output terminal of the flip-flop 32 is connected to the level shift circuit 36. The level shift circuit 36 level-shifts a Q output of the flip-flop 32 to a logic signal based on the electric potential of the node PA from a logic signal based on the reference potential. An output of the level shift circuit 36 is output to the gate of the first transistor MTR1 via the two inverters 37 and 38 connected in series. The diode 39 is a diode for bootstrap, and the capacitance 40 is a capacitance for bootstrap.

Next, there will be explained an operation.

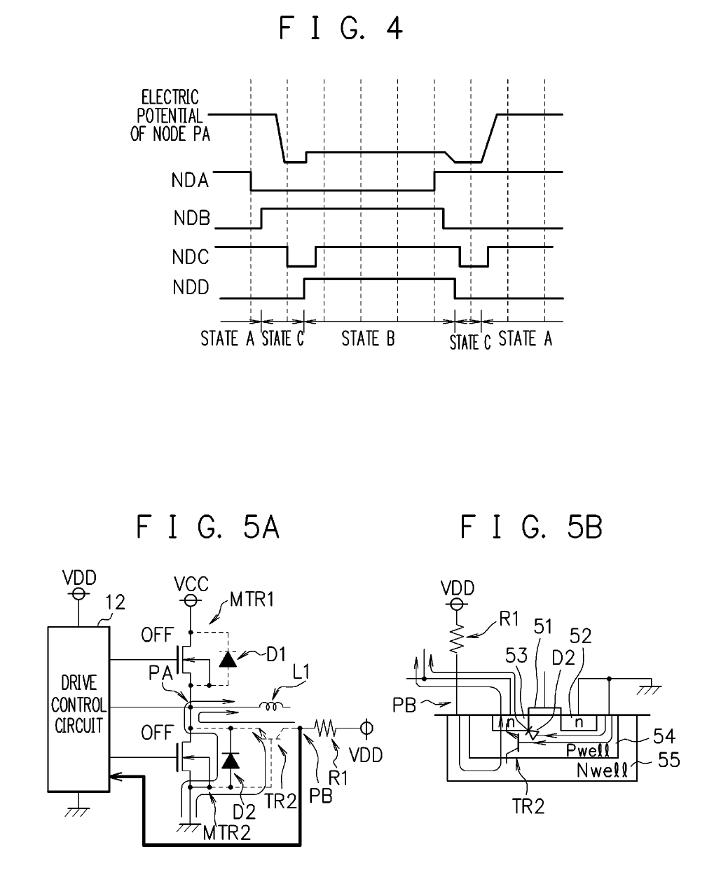

First, there is explained a control related to the second transistor MTR2 performed when the second transistor MTR2 is switched to off, to on, and to off, namely when the state is switched to the state A, to the state C, to the state B, and to the state C with reference to FIG. 4. FIG. 4 is a timing chart illustrating an operation example of the power supply circuit in the first embodiment.

In the state A where the second transistor MTR2 is off and the first transistor MTR1 is on, the PWM signal PWMCS (NDA) is “H,” so that the RESET input of the flip-flop 31 (NDB) is “L.” Thus, the flip-flop 31 is reset, and the Q output (NDD) is “L.”

When the PWM signal PWMCS (NDA) changes to “L” from “H” in order to turn on the second transistor MTR2, the RESET input of the flip-flop 31 (NDB) changes to “H” from “L” and reset of the flip-flop 31 is canceled. Further, when as will be described later, the first transistor MTR1 is turned off immediately and the first and second transistors MTR1 and MTR2 are both turned off (the state C), as illustrated by current paths in FIG. 5A and FIG. 5B, an electric current is supplied to the node PA from the reference potential via the parasitic diode D2 between a back gate (a P well) 54 and a drain 53 of the second transistor MTR2. Further, the electric potential of the node PA (the drain 53) becomes an electric potential lower than the reference potential (for example, −Vf) and from the power supply voltage VDD connected to an N well 55 via the resistor R1, an electric current is supplied to the node PA via the parasitic NPN transistor TR2. In FIG. 5B, 51 denotes a gate and 52 denotes a source.

As described above, when the first and second transistors MTR1 and MTR2 are both turned off, an electric current flows through the parasitic diode D2 and the parasitic NPN transistor TR2, the electric potential of the node PA decreases, and the electric potential of the node PB (NDC) decreases. Then, when the electric potential of the node PB (NDC), in other words, the electric potential of the collector of the parasitic NPN transistor TR2 becomes lower than a threshold value of the inverter 33, the CK input of the flip-flop 31 changes to “H” from “L.” Thereby, the Q output of the flip-flop 31 (NDD) changes to “H” and the second transistor MTR2 is turned on (the state B). When the second transistor MTR2 is turned on, the electric current to flow through the parasitic diode D2 and the parasitic NPN transistor TR2 stops flowing and the electric potential of the node PB (NDC) increases to “H.”

Thereafter, when the PWM signal PWMCS (NDA) changes to “H” from “L” in order to turn the first transistor MTR1 on (turn the second transistor MTR2 off), the RESET input of the flip-flop 31 (NDB) changes to “L” from “H” and the flip-flop 31 is reset. Thus, when the PWM signal PWMCS (NDA) changes to “H” from “L,” the Q output of the flip-flop 31 (NDD) changes to “L” immediately and the second transistor MTR2 is turned off (the state C).

Next, with reference to FIG. 6, there will be explained a control related to the first transistor MTR1 performed when the first transistor MTR1 is switched to off, to on, and to off, namely when the state is switched to the state B, to the state C, to the state A, and to the state C. FIG. 6 is a timing chart illustrating an operation example of the power supply circuit in the first embodiment.

In the state B where the first transistor MTR1 is off and the second transistor MTR2 is on, the PWM signal PWMCS (NDA) is “L” and the RESET input of the flip-flop 32 (NDA) is “L.” Thus, the flip-flop 32 is reset, the Q output (NDE) is “L,” and the gate of the first transistor MTR1 is “L.”

When the PWM signal PWMCS (NDA) changes to “H” from “L” in order to turn the first transistor MTR1 on, the RESET input of the flip-flop 32 (NDA) changes to “H” from “L” and reset of the flip-flop 32 is canceled. Further, when the second transistor MTR2 is immediately turned off and the first and second transistors MTR1 and MTR2 are both turned off (the state C) as described previously, as illustrated in the current paths in FIG. 5A and FIG. 5B, an electric current flows to the node PA, the electric potential of the node PA decreases, and the electric potential of the node PB (NDC) decreases.

Then, when the electric potential of the node PB (NDC), in other words, the electric potential of the collector of the parasitic NPN transistor TR2 becomes lower than a threshold value of the inverter 34, the CK input of the flip-flop 32 changes to “H” from “L.” Thereby, the Q output of the flip-flop 32 (NDE) changes to “H” and the first transistor MTR1 is turned on (the state A). When the first transistor MTR1 is turned on, the electric current to flow through the parasitic diode D2 and the parasitic NPN transistor TR2 of the second transistor MTR2 stops flowing and the electric potential of the node PB (NDC) increases to “H.”

Thereafter, when the PWM signal PWMCS (NDA) changes to “L” from “H” in order to turn the second transistor MTR2 on (turn the first transistor MTR1 off), the RESET input of the flip-flop 32 (NDA) changes to “L” from “H” and the flip-flop 32 is reset. Therefore, when the PWM signal PWMCS (NDA) changes to “L” from “H,” the Q output of the flip-flop 32 (NDE) changes to “L” immediately and the first transistor MTR1 is turned off (the state C).

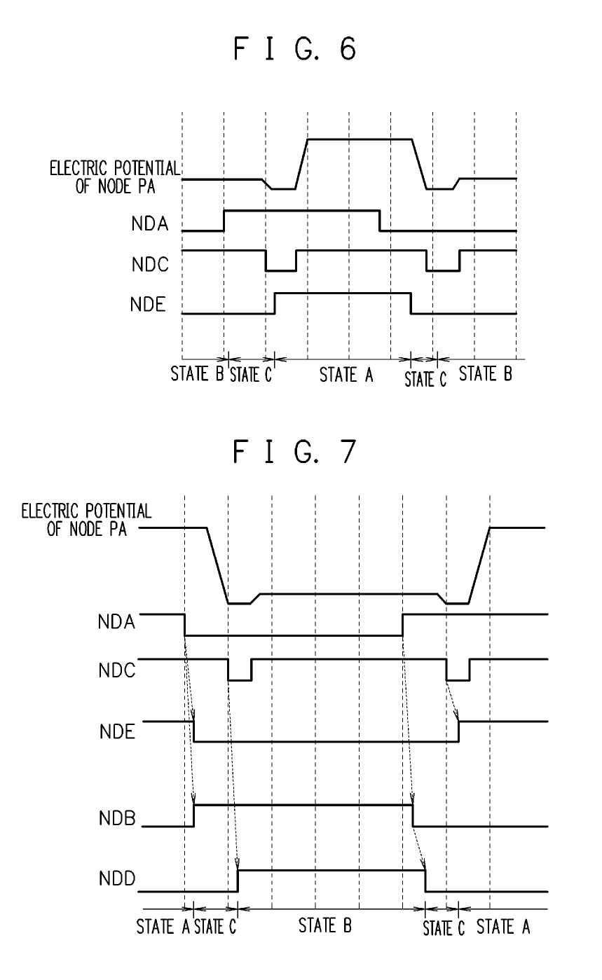

The controls related to the previously described first and second transistors MTR1 and MTR2 are summarized to be illustrated in FIG. 7. The first and second transistors MTR1 and MTR2 are controlled so that a node NDE related to the control of the first transistor MTR1 and a node NDD related to the control of the second transistor MTR2 may not change to “H” simultaneously but both change to “L” and then one of the node NDE and the node NDD may change to “H,” and the dead time when the first and second transistors MTR1 and MTR2 are both turned off is provided appropriately.

According to the first embodiment, the power supply circuit detects that the first and second transistors MTR1 and MTR2 are both turned off by the electric potential of the collector of the parasitic NPN transistor TR2 of the second transistor MTR2 (the N well of the second transistor MTR2), to turn on the first transistor MTR1 or the second transistor MTR2. Thereby, it is possible to optimize the dead time and to improve efficiency decrease in the DC-DC converter.

### Second Embodiment

Next, there will be explained a second embodiment.

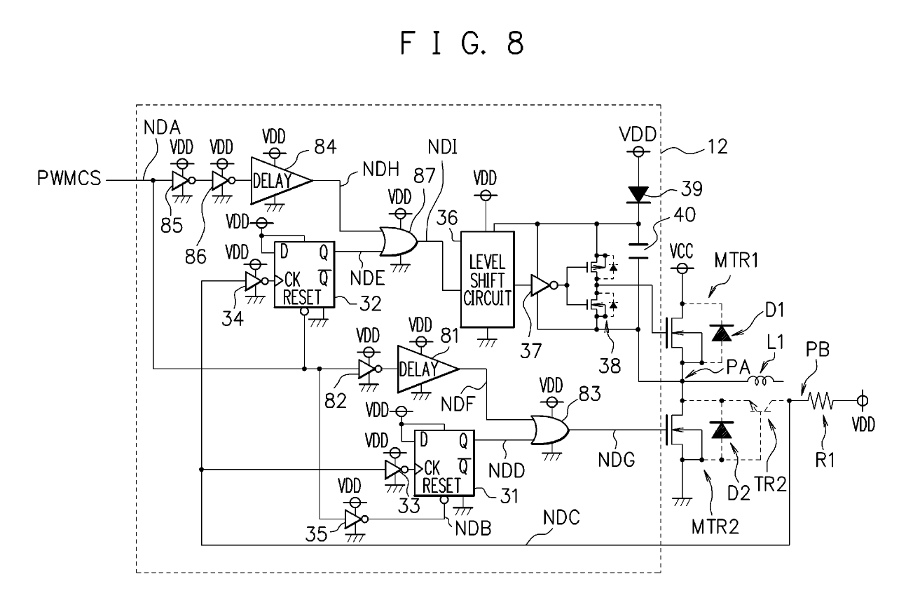

A power supply circuit in the second embodiment is different in the configuration of the drive control circuit 12 from the previously described power supply circuit in the first embodiment. The other configuration of the power supply circuit in the second embodiment is similar to that of the first embodiment, so that its explanation is omitted. FIG. 8 is a view illustrating a configuration example of a drive control circuit 12 in the second embodiment. In FIG. 8, the same symbols and numerals are given to components having the same functions as those of the components illustrated in FIG. 3, and redundant explanations are omitted.

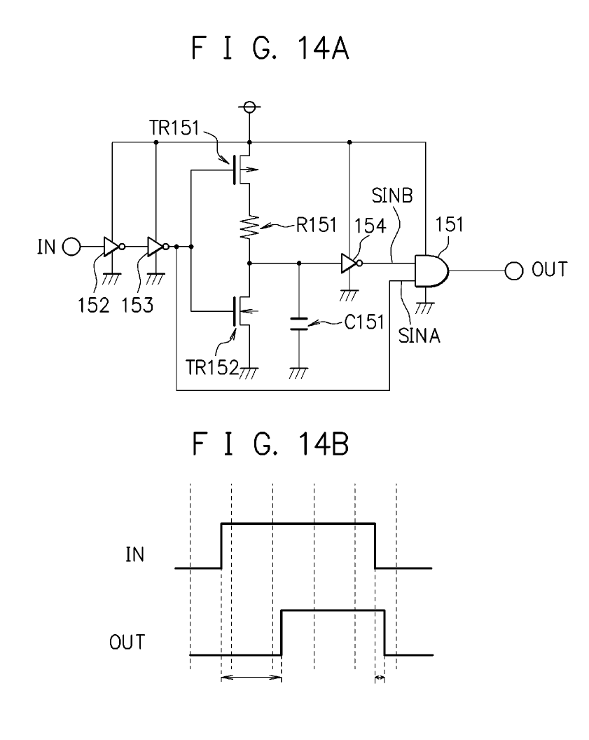

The drive control circuit 12 in the second embodiment includes delay circuits 81 and 84, inverters 82, 85, and 86, and logical sum operation circuits (OR circuits) 83 and 87, in additions to the flip-flops 31 and 32, the inverters 33 to 35, 37, and 38, the level shift circuit 36, the diode 39, and the capacitance 40. The delay circuits 81 and 84 are the delay circuit illustrated in FIG. 14A and FIG. 14B, for example, and when an input signal changes to “H” from “L,” they delay an output signal to change it to “H” from “L,” and when the input signal changes to “L” from “H,” they immediately change the output signal to “L” from “H.”

The PWM signal PWMCS is input to the delay circuit 81 via the inverter 82. The OR circuit 83 receives the Q output of the flip-flop 31 and an output of the delay circuit 81 to output an operation result of the outputs to the gate of the second transistor MTR2. The PWM signal PWMCS is input to the delay circuit 84 via the two inverters 85 and 86 connected in series. The OR circuit 87 receives the Q output of the flip-flop 32 and an output of the delay circuit 84 to output an operation result of the outputs to the level shift circuit 36.

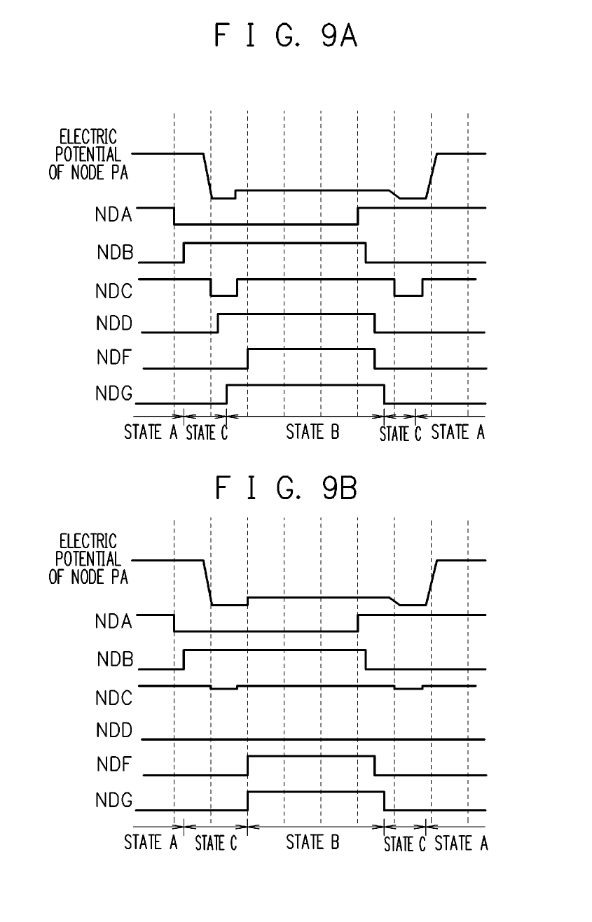

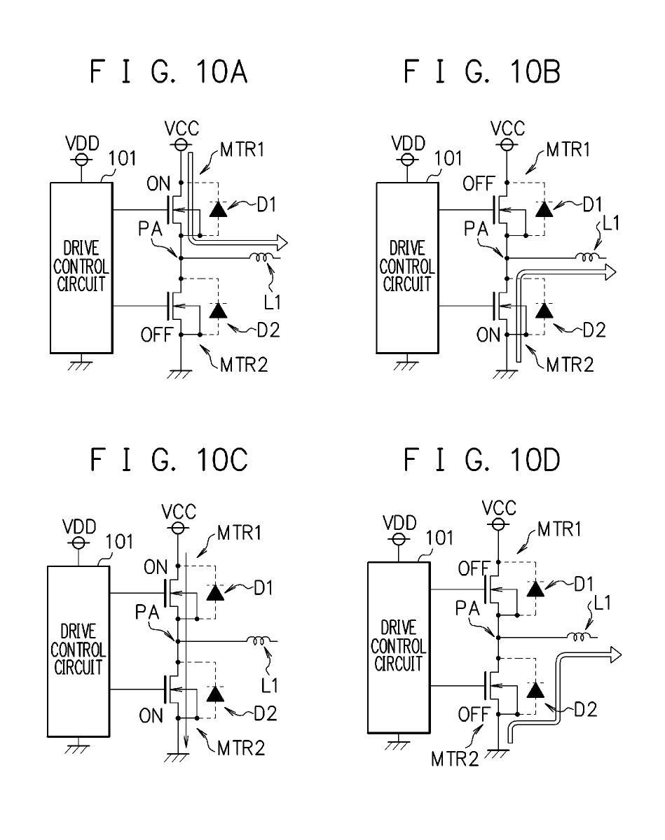

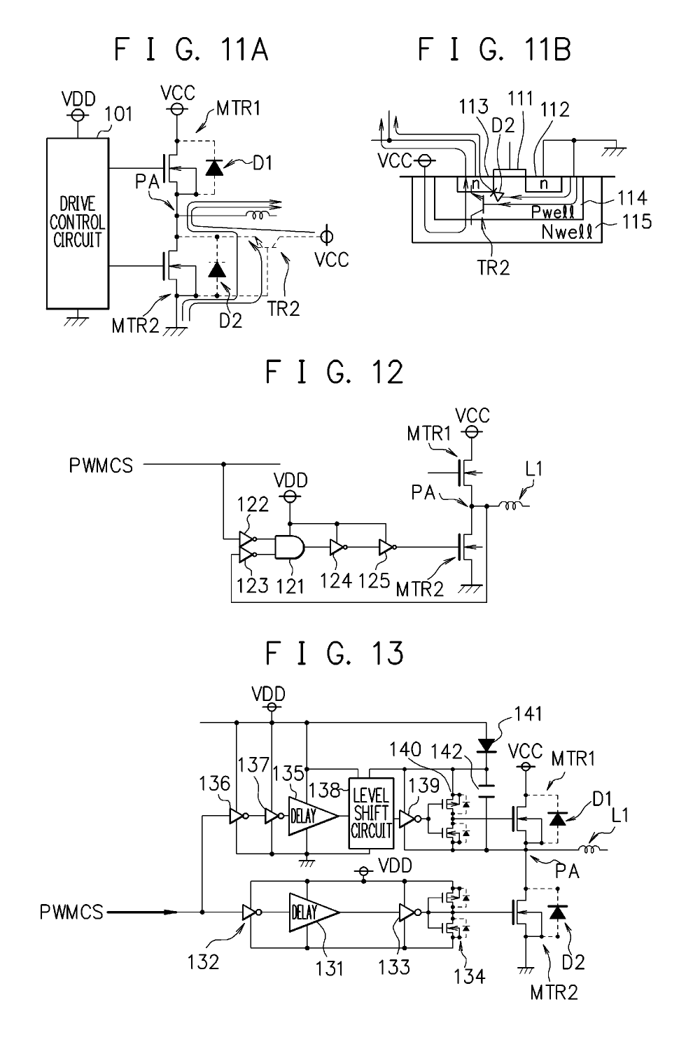

With reference to FIG. 9A and FIG. 9B, there will be explain a control related to the second transistor MTR2 performed when the second transistor MTR2 is switched to off, to on, and to off, namely when the state is switched to the state A, to the state C, to the state B, and to the state C. FIG. 9A and FIG. 9B are timing charts each illustrating an operation example of the power supply circuit in the second embodiment.

FIG. 9A illustrates an example where a load current is large, and at the dead time when the first and second transistors MTR1 and MTR2 are both turned off, the electric potential of the node PB becomes lower than a threshold value of the inverter 33. First, in the state A where the second transistor MTR2 is off and the first transistor MTR1 is on, the PWM signal PWMCS (NDA) is “H,” so that the RESET input of the flip-flop 31 (NDB) is “L” and the Q output of the flip-flop 31 (NDD) is “L.” The output of the delay circuit 81 (NDF) is also “L” and the output of the OR circuit 83 (NDG) is “L.”

When the PWM signal PWMCS (NDA) changes to “L” from “H” in order to turn the second transistor MTR2 on, the RESET input of the flip-flop 31 (NDB) changes to “H” from “L” and reset of the flip-flop 31 is canceled. Further, when the first transistor MTR1 is immediately turned off and the first and second transistors MTR1 and MTR2 are both turned off (the state C), as illustrated in the current paths in FIG. 5A and FIG. 5B, an electric current is supplied to the node PA, the electric potential of the node PA decreases, and the electric potential of the node PB (NDC) decreases.

Then, when the electric potential of the node PB (NDC) becomes lower than a threshold value of the inverter 33 before the output of the delay circuit 81 (NDF) changes to “H” from “L,” the CK input of the flip-flop 31 changes to “H” from “L.” Thereby, the Q output of the flip-flop 31 (NDD) changes to “H,” the output of the OR circuit 83 (NDG) changes to “H,” and the second transistor MTR2 is turned on (the state B). When the second transistor MTR2 is turned on, the electric current to flow through the parasitic diode D2 and the parasitic NPN transistor TR2 stops flowing and the electric potential of the node PB (NDC) increases to “H.” Further, the output of the delay circuit 81 (NDF) changes to “H” from “L” after a certain delay time elapses.

Thereafter, when the PWM signal PWMCS (NDA) changes to “H” from “L” in order to turn the first transistor MTR1 on (turn the second transistor MTR2 off), the RESET input of the flip-flop 31 (NDB) changes to “L” from “H” and the flip-flop 31 is reset. Thus, when the PWM signal PWMCS (NDA) changes to “H” from “L,” the Q output of the flip-flop 31 (NDD) immediately changes to “L.” Further, when the PWM signal PWMCS (NDA) changes to “H” from “L,” the output of the delay circuit 81 (NDF) also changes to “L” from “H” immediately. Thus, the output of the OR circuit 83 (NDG) changes to “L” and the second transistor MTR2 is turned off (the state C).

Here, when the load current is small, there is caused a risk that at the dead time when the first and second transistors MTR1 and MTR2 are both turned off, the electric potential of the node PB does not become lower than a threshold value of the inverter 33. FIG. 9B illustrates an example where the load current is small, and at the dead time when the first and second transistors MTR1 and MTR2 are both turned off, the electric potential of the node PB does not become lower than a threshold value of the inverter 33. The explanation of the state A where the second transistor MTR2 is off and the first transistor MTR1 is on is similar to that described previously.

When the PWM signal PWMCS (NDA) changes to “L” from “H” in order to turn the second transistor MTR2 on, the RESET input of the flip-flop 31 (NDB) changes to “H” from “L” and reset of the flip-flop 31 is canceled. Further, when the first transistor MTR1 is immediately turned off and the first and second transistors MTR1 and MTR2 are both turned off (the state C), as illustrated in the current paths in FIG. 5A and FIG. 5B, an electric current flows to the node PA, the electric potential of the node PA decreases, and the electric potential of the node PB (NDC) decreases.

However, when the load current is small, the state where the electric potential of the node PB is higher than a threshold value of the inverters 33 and 34 is maintained. In this case, the CK input of the flip-flop 31 does not change to “H” from “L” and the Q output of the flip-flop 31 (NDD) remains at “L.” Then, the PWM signal PWMCS (NDA) changes to “L” from “H” and then a predetermined delay time elapses, and then the output of the delay circuit 81 (NDF) changes to “H” from “L.” Thereby, the output of the OR circuit 83 (NDG) changes to “H” and the second transistor MTR2 is turned on (the state B).

The explanation of the operation that the PWM signal PWMCS (NDA) thereafter changes to “H” from “L” in order to turn the first transistor MTR1 on (turn the second transistor MTR2 off) is similar to that described previously.

Incidentally, the control related to the first transistor MTR1 performed when the first transistor MTR1 is switched to off, to on, and to off, namely when the state is switched to the state B, to the state C, to the state A, and to the state C, is similar to that related to the second transistor MTR2 described previously. That is, when the load current is large and the electric potential of the node PB becomes lower than a threshold value of the inverter 34 at the dead time when the first and second transistors MTR1 and MTR2 are both turned off, the Q output of the flip-flop 32 (NDE) changes to “H,” and thereby the output of the OR circuit 87 (NDI) changes to “H” and the first transistor MTR1 is turned on. On the other hand, when the load current is small and the electric potential of the node PB does not become lower than a threshold value of the inverter 34 at the dead time when the first and second transistors MTR1 and MTR2 are both turned off, the output of the delay circuit 84 (NDH) changes to “H,” and thereby the output of the OR circuit 87 (NDI) changes to “H” and the first transistor MTR1 is turned on.

According to the second embodiment, the effect similar to that of the first embodiment can be obtained, and when the load current is small and the change in electric potential of the node PB is small at the dead time, it is possible to securely turn on one of the transistors MTR1 and MTR2 after a predetermined delay time elapses, and to achieve appropriate driving of the transistors MTR1 and MTR2.

In the previously described embodiments, the collector of the parasitic NPN transistor TR2 of the second transistor MTR2 (the N well of the second transistor MTR2) is connected to the power supply voltage VDD that is the same as the voltage to be supplied to the drive control circuit 12 via the resistor R1, but the voltage to which the collector of the parasitic NPN transistor TR2 of the second transistor MTR2 (the N well of the second transistor MTR2) is connected via the resistor R1 is not limited to this. The voltage to which the collector of the parasitic NPN transistor TR2 of the second transistor MTR2 (the N well of the second transistor MTR2) is connected via the resistor R1 only needs to be a voltage higher than the voltage to be supplied to the back gate (the P well) of the second transistor MTR2 and lower than a gate withstand voltage of transistors to receive the electric potential of the node PB in the drive control circuit 12.

It should be noted that the above-described embodiments merely illustrate a concrete example of implementing the present embodiment, and the technical scope of the present embodiment is not to be construed in a restrictive manner by the embodiments. That is, the present embodiment may be implemented in various forms without departing from the technical spirit or main features thereof.

The disclosed control circuit detects that the first transistor and the second transistor are both off by the electric potential of the N well connected to the wiring to which a second voltage lower than a first voltage is supplied via the resistor, and turns one of the transistors on, so that it is possible to optimize the dead time even when a gate withstand voltage of a transistor in the drive control circuit is lower than the first voltage.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control circuit, comprising:
a signal generating circuit configured to generate a pulse width modulation signal; and
a drive control circuit configured to alternately turn on a first transistor and a second transistor in accordance with the pulse width modulation signal, the first transistor and the second transistor being connected in series between a wiring to which a first voltage is supplied and a wiring to which a reference potential is supplied, wherein
at least one of the first transistor and the second transistor is formed in a P well formed in an N well, and an N-type diffusion layer to be a source or a drain is formed in the P well,
the N well is connected to a wiring to which a second voltage lower than the first voltage is supplied via a resistor, and
the drive control circuit includes a first drive circuit configured to turn on one of the first transistor and the second transistor when detecting that an electric potential of the N well of the first transistor or the second transistor becomes lower than a first threshold value after the other of the first transistor and the second transistor is turned off.

2. The control circuit according to claim 1, wherein
the first drive circuit includes a flip-flop having a reset input terminal to which the pulse width modulation signal is input, a clock input terminal to which the electric potential of the N well is input, and a data input terminal to which a signal of a logic level different from a logic level of a data output at the time of a reset is input, and the first drive circuit is configured to turn on the first transistor or the second transistor on the basis of the data output of the flip-flop.

3. The control circuit according to claim 1, wherein
the drive control circuit includes a second drive circuit configured to turn on the one of the first transistor and the second transistor by a signal obtained by delaying the pulse width modulation signal, and
when at least one of the first drive circuit and the second drive circuit indicates turning on the one of the first transistor and the second transistor, the drive control circuit turns on the one of the first transistor and the second transistor.

4. The control circuit according to claim 3, wherein
the second drive circuit includes a delay circuit configured to delay the pulse width modulation signal in the case of turning on the one of the first transistor and the second transistor and outputs the pulse width modulation signal without delaying the pulse width modulation signal in the case of turning off the one of the first transistor and the second transistor.

5. The control circuit according to claim 3, wherein
the drive control circuit includes a third drive circuit configured to turn on the other of the first transistor and the second transistor by a signal obtained by delaying the pulse width modulation signal.

6. The control circuit according to claim 1, wherein
the drive control circuit includes a fourth drive circuit configured to turn on the other of the first transistor and the second transistor when detecting that an electric potential of the N well of the first transistor or the second transistor becomes lower than a second threshold value after the one of the first transistor and the second transistor is turned off.

7. The control circuit according to claim 1, wherein
the second voltage is a power supply voltage to be supplied to the drive control circuit.

8. A power supply circuit, comprising:
a first transistor and a second transistor configured to supply an electric current to a load circuit, the first transistor and the second transistor being connected in series between a wiring to which an input voltage is supplied and a wiring to which a reference potential is supplied;
a signal generating circuit configured to generate a pulse width modulation signal on the basis of an output voltage to the load circuit; and
a drive control circuit configured to alternately turn on the first transistor and the second transistor in accordance with the pulse width modulation signal, wherein
at least one of the first transistor and the second transistor is formed in a P well formed in an N well, and an N-type diffusion layer to be a source or a drain is formed in the P well,
the N well is connected to a wiring to which a first voltage lower than the input voltage is supplied via a resistor, and
the drive control circuit includes a first drive circuit configured to turn on one of the first transistor and the second transistor when detecting that an electric potential of the N well of the first transistor or the second transistor becomes lower than a first threshold value after the other of the first transistor and the second transistor is turned off.

9. The power supply circuit according to claim 8, further comprising:
a coil being provided between a connection point of the first transistor and the second transistor and the load circuit.

10. The power supply circuit according to claim 8, wherein
the first drive circuit includes a flip-flop having a reset input terminal to which the pulse width modulation signal is input, a clock input terminal to which the electric potential of the N well is input, and a data input terminal to which a signal of a logic level different from a logic level of a data output at the time of a reset is input, and the first drive circuit is configured to turn on the first transistor or the second transistor on the basis of the data output of the flip-flop.

11. The power supply circuit according to claim 8, wherein
the drive control circuit includes a second drive circuit configured to turn on the one of the first transistor and the second transistor by a signal obtained by delaying the pulse width modulation signal, and
when at least one of the first drive circuit and the second drive circuit indicates turning on the one of the first transistor and the second transistor, the drive control circuit turns on the one of the first transistor and the second transistor.

12. The power supply circuit according to claim 11, wherein
the second drive circuit includes a delay circuit configured to delay the pulse width modulation signal in the case of turning on the one of the first transistor and the second transistor and outputs the pulse width modulation signal without delaying the pulse width modulation signal in the case of turning off the one of the first transistor and the second transistor.

13. The power supply circuit according to claim 11, wherein
the drive control circuit includes a third drive circuit configured to turn on the other of the first transistor and the second transistor by a signal obtained by delaying the pulse width modulation signal.

14. The power supply circuit according to claim 8, wherein
the drive control circuit includes a fourth drive circuit configured to turn on the other of the first transistor and the second transistor when detecting that an electric potential of the N well of the first transistor or the second transistor becomes lower than a second threshold value after the one of the first transistor and the second transistor is turned off.

15. The power supply circuit according to claim 8, wherein
the first voltage is a power supply voltage to be supplied to the drive control circuit.
